(19) United States
(12) Patent Application Publication
(10) Pub. No.: US 2007/0036483 A1
(43) Pub. Date: Feb. 15, 2007

(54) Wavelength-division-multiplexed light source and wavelength-division-multiplexed passive optical network using the same

(75) Inventors: Dong-Jae Shin, Suwon-si (KR); Hyun-Soo Kim, Suwon-si (KR); Hong-Seok Shin, Suwon-si (KR); Sung-Bum Park, Suwon-si (KR); Dae-Kwang Jung, Suwon-si (KR); Seong-Taek Hwang, Pyeongtaek-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/502,826

(22) Filed: Aug. 10, 2006

(30) Foreign Application Priority Data
Aug. 12, 2005 (KR) 2005-74363

(51) Int. Cl. G02B 6/28

(52) U.S. Cl. 385/24

(57) ABSTRACT

A wavelength-division-multiplexed light source for transmitting broadband light through a fiber and receiving an optical signal through the fiber is disclosed. The wavelength-division-multiplexed light source includes: a light source for outputting broadband light; and a coupler for outputting the broadband light, which has been input from the light source, to the fiber through cross coupling, and outputting an optical signal, which has been input from the fiber, through bar coupling, based on a predetermined cross coupling ratio, wherein the cross coupling ratio of the coupler is adjusted depending on a power of the optical signal.

### CLAIM OF PRIORITY

This application claims the benefit under 35 U.S.C. 119(a) of an application entitled “Wavelength-Division-Multiplexed Light Source And Wavelength-Division-Multiplexed Passive Optical Network Using The Same,” filed in the Korean Intellectual Property Office on Aug. 12, 2005 and assigned Serial No. 2005-74363, the entire contents of which are incorporated herein by reference.

### BACKGROUND OF THE INVENTION

1. Field of the Invention

The present invention relates to a wavelength-division-multiplexed light source applicable to a wavelength-division-multiplexed passive optical network (WDM PON).

2. Description of the Related Art

In order to reduce the maintenance cost for a wavelength-division-multiplexed passive optical network (WDM PON), it is necessary to provide an economical wavelength alignment between the light sources and the wavelength division multiplexers. To achieve this in various networks, in which a wavelength division multiplexer is combined with a distributed feedback laser array, a high-power light emitting diode array or an erbium-doped fiber amplifier have been proposed. Recently, a light source having an external light injection, the output wavelength of which is determined by light injected from the exterior and not by the light source itself, has been proposed. The light sources with the external light injection include a Fabry-Perot laser diode (FP-LD) and a reflective semiconductor optical amplifier (R-SOA). Such light sources have an advantage in that light sources of the same type can output optical signals having different wavelengths without any particular need of adjustment as the wavelength of each light source is determined by an injection light. Therefore, in the case of using the light sources with external light injection, the wavelength alignment between light sources and a wavelength division multiplexer is not required, thereby simplifying management and maintenance of the network. An efficient injection light source is required to make the best use of such an advantage. Presently, broadband light sources, such as an erbium-doped fiber amplifier (EDFA) and a reflective semiconductor optical amplifier, having a wide bandwidth are widely used as an injection light source.

Meanwhile, technology using a circulator or 3 dB coupler has been proposed in order to transmit upstream-band light, which is generated by a central office (CO), to a subscriber-side apparatus (SUB) through a transmission fiber. When the circulator is used, there is an advantage of reducing transmission loss of optical signals, but there is a disadvantage of requiring a high cost. Also, when the 3 dB coupler is used, there is an advantage of having a low cost, but there is a disadvantage of causing a 3 dB coupling loss in an upstream-band light and an upstream optical signal, respectively. In addition, the power of an upstream optical signal output from each light source with external light injection, which is included in the subscriber-side apparatus, is proportional to the power of an injection light input to the light source with external light injection.

However, the conventional wavelength-division-multiplexed passive optical network uses a 3 dB coupler causing a fixed coupling loss, without taking into consideration the loss characteristic of a transmission optical signal which is varied depending on subscriber environments, thereby being inefficient and degrading quality of signals.

Accordingly, it has been highly required to develop a new wavelength-division-multiplexed light source capable of efficiently maintaining the signal quality by reflecting loss characteristics of transmission optical signals therein, and a wavelength-division-multiplexed passive optical network using the new wavelength-division-multiplexed light source.

### SUMMARY OF THE INVENTION

Accordingly, the present invention has been made to solve the above-mentioned problems occurring in the prior art and provides additional advantages, by providing a wavelength-division-multiplexed light source capable of efficiently maintaining the signal quality by reflecting loss characteristics of transmission optical signals therein, and a wavelength-division-multiplexed passive optical network using the new wavelength-division-multiplexed light source.

In accordance with one aspect of the present invention, there is provided a wavelength-division-multiplexed light source for transmitting broadband light through a fiber and receiving an optical signal through the fiber, the wavelength-division-multiplexed light source comprising: a light source for outputting broadband light; and a coupler for outputting the broadband light, which has been input from the light source, to the fiber through cross coupling, and outputting an optical signal, which has been input from the fiber, through bar coupling, based on a predetermined cross coupling ratio, wherein the cross coupling ratio of the coupler is adjusted depending on a power of the optical signal.

In accordance with another aspect of the present invention, there is provided a wavelength-division-multiplexed passive optical network comprising: a central office; and a subscriber-side apparatus connected to the central office through a feeder fiber, wherein the central office comprises an upstream broadband light source for outputting upstream-band light; a plurality of optical transceivers for detecting input upstream optical signals; a coupler for outputting the upstream-band light, which has been input from the upstream broadband light source, to the feeder fiber through cross coupling, and outputting upstream optical signals, which have been input from the feeder fiber, to the optical transceivers through bar coupling, based on a predetermined cross coupling ratio; and a controller for adjusting the cross coupling ratio of the coupler depending on powers of the detected upstream optical signals.

### BRIEF DESCRIPTION OF THE DRAWINGS

The above features and advantages of the present invention will be more apparent from the following detailed description taken in conjunction with the accompanying drawings, in which:

FIG. 1 is a block diagram illustrating the construction of a wavelength-division-multiplexed passive optical network according to an embodiment of the present invention;

FIG. 2 is a view for explaining the light coupling characteristics of the coupler shown in FIG. 1;

FIG. 3 is a graph illustrating the loss characteristic as a function of cross coupling ratios in the coupler shown in FIG. 1; and

FIG. 4 is a flowchart illustrating the control algorithm of the controllers shown in FIG. 1.

### DETAILED DESCRIPTION

Hereinafter, an embodiment of the present invention will be described with reference to the accompanying drawings. For the purposes of clarity and simplicity, a detailed description of known functions and configurations incorporated herein will be omitted as it may obscure the subject matter of the present invention.

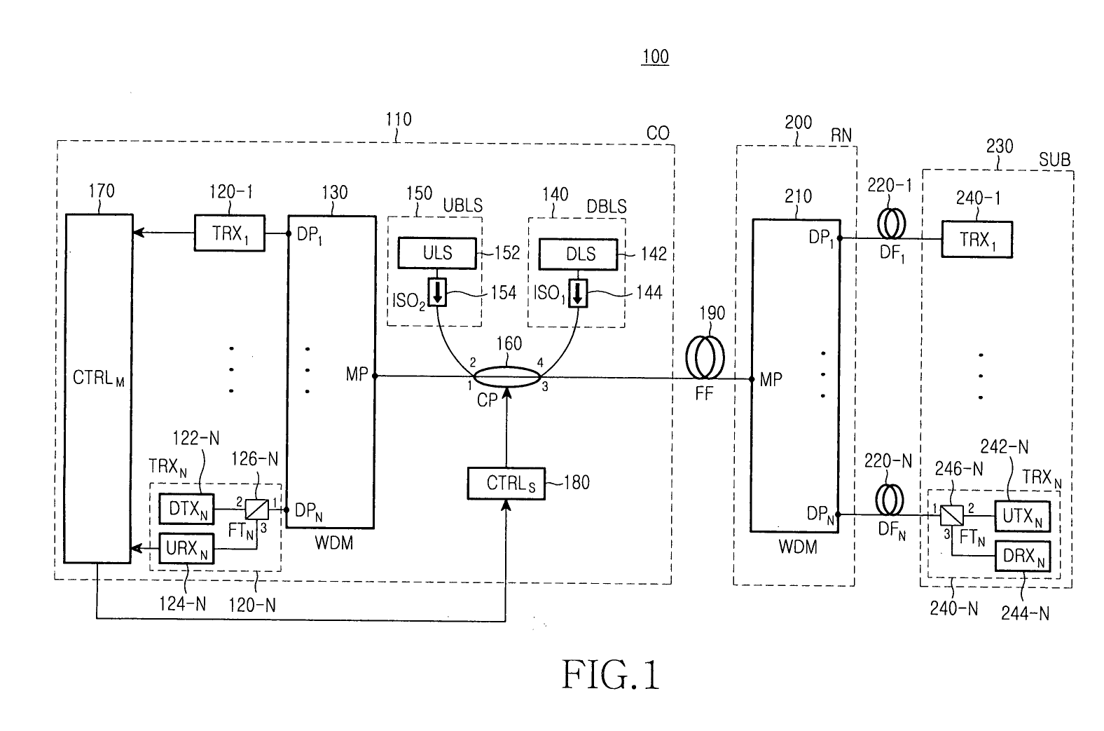

FIG. 1 is a block diagram illustrating the construction of a wavelength-division-multiplexed passive optical network according to an embodiment of the present invention. As shown, the passive optical network 100 includes a central office (CO) 110, a remote node (RN) 200 connected to the central office 110 through a feeder fiber (FF) 190, and a subscriber-side apparatus (SUB) 230 connected to the remote node 200 through first to N^{th} distribution fibers (DF) 220-1 to 220-N.

The central office 110 transmits multiplexed downstream optical signals to the remote node 200 and receives multiplexed upstream optical signals from the remote node 200. The central office 110 includes a downstream broadband light source (DBLS) 140, an upstream broadband light source (UBLS) 150, a coupler (CP) 160, a wavelength division multiplexer (WDM) 130, first to N^{th} optical transceivers (TRX) 120-1 to 120-N, and a control unit including a main controller (CTRL_{M}) 170 and a secondary controller (CTRL_{S}) 180. Note that the elements of the central office 110 form a wavelength-division-multiplexed light source.

The downstream broadband light source 140 outputs downstream-band light and may include a downstream light source (DLS) 142 and a first isolator (ISO) 144.

The downstream light source 142 outputs the downstream-band light including all wavelengths of downstream optical signals. The downstream light source 142 includes an erbium-doped fiber amplifier, a semiconductor optical amplifier, etc.

The first isolator 144 allows downstream-band light, which is input thereto from the downstream light source 142, to pass therethrough and shield the light input thereto in a reverse direction.

The upstream broadband light source 150 outputs upstream-band light and may include an upstream light source (ULS) 152 and a second isolator 154.

The upstream light source 152 outputs upstream-band light including all wavelengths of upstream optical signals. The downstream light source 152 includes an erbium-doped fiber amplifier, a semiconductor optical amplifier, etc.

The second isolator 154 allows upstream-band light, which is input thereto from the upstream light source 152, to pass therethrough, and shields the light input thereto in a reverse direction.

The coupler 160 includes four ports, in which a first port is connected to the wavelength division multiplexer 130, a second port is connected to second isolator 154, a third port is connected to the feeder fiber 190, and a fourth port is connected to the first isolator 144. The coupler 160 connects the first and third ports through a bar coupling, connects the second and fourth ports through a bar coupling, connects the first and fourth ports through a cross coupling, and connects the second and third ports through a cross coupling. The coupler 160 outputs light, which has been input through any one port, to two other ports connected with said any one port, based on a predetermined cross coupling ratio.

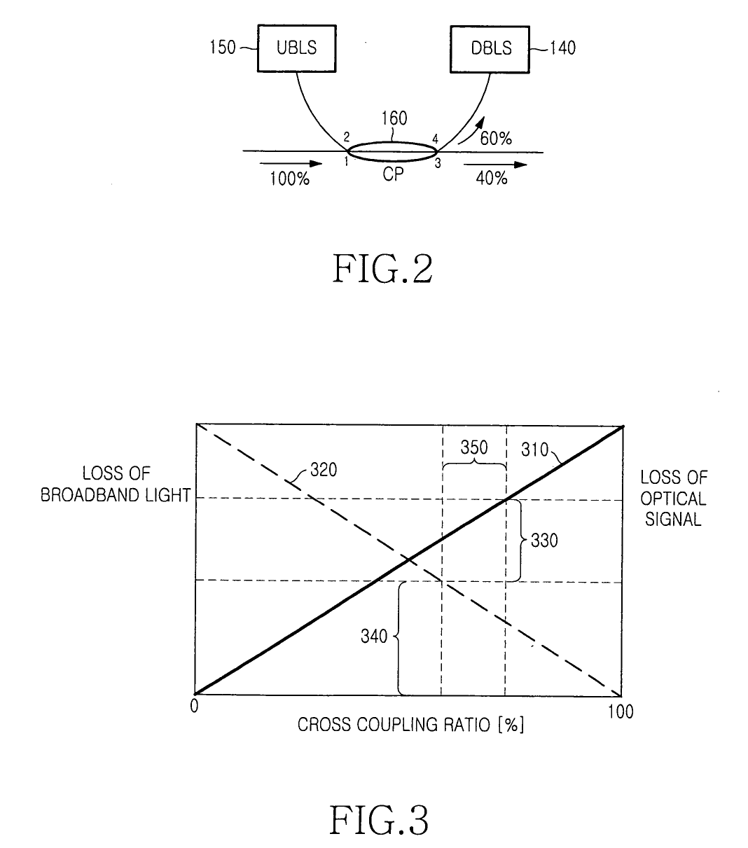

FIG. 2 shows the light coupling characteristics of the coupler 160. In particular, FIG. 2 shows a case in which light is input through the first port of the coupler 160, in which the coupler 160 is assumed to have a cross coupling ratio of 60%. The coupler 160 outputs 40% of the light, which has been input through the first port, to the third port through the bar coupling, and outputs the remaining 60% of the input light to the fourth port through the cross coupling.

Referring back to FIG. 1, the coupler 160 outputs downstream-band light, which has been input through the fourth port, to the first port through the cross coupling; outputs upstream-band light, which has been input through the second port, to the third port through the cross coupling; outputs a downstream optical signal, which has been input through the first port, to the third port through the bar coupling; and outputs an upstream optical signal, which has been input through the third port, to the first port through the bar coupling. In addition, the cross coupling ratio of the coupler 160 is selectively adjusted according to the control of the secondary controller 180.

As described above, since the coupler 160 has a predetermined cross coupling ratio, an optical signal output through the bar coupling has a loss by an amount equivalent to a cross-coupled optical signal, and an optical signal output through the cross coupling has a loss by an amount equivalent to a bar-coupled optical signal.

FIG. 3 is a graph illustrating the loss characteristic as a function of cross coupling ratios in the coupler 160. In FIG. 3, a solid line represents a loss curve 310 for an optical signal, and a dotted line represents a loss curve 320 for broadband light. As a cross coupling ratio decreases, the power of broadband light output through the cross coupling decreases, and the power of an optical signal output through the bar coupling increases. In contrast, as a cross coupling ratio increases, the power of broadband light output through the cross coupling increases, and the power of an optical signal output through the bar coupling decreases. In order to satisfy the required signal quality, a permissible range 330 of loss of an optical signal may be established, and a permissible range 340 of loss of broadband light may be established. An optimum range 350 for the cross coupling ratio of the coupler 160 is established so as to satisfy these permissible ranges 330 and 340.

Referring back to FIG. 1, the wavelength division multiplexer 130 includes a multiplexing port (MP) and first to N^{th} demultiplexing ports (DP). The multiplexing port is connected to the first port of the coupler 160, and the first to N^{th} demultiplexing ports are connected to the first to N^{th} optical transceivers 120-1 to 120-N in one-to-one relationship. The wavelength division multiplexer 130 spectrum-slices downstream-band light input through its multiplexing port so as to generate first to N^{th} downstream injection light, and outputs the generated first to N^{th} downstream injection light through the first to N^{th} demultiplexing ports in one-to-one relationship. Also, the wavelength division multiplexer 130 demultiplexes a multiplexed upstream optical signal input through its multiplexing port into first to N^{th} upstream optical signals, and outputs the first to N^{th} upstream optical signals to the first to N^{th} demultiplexing ports in one-to-one relationship. The wavelength division multiplexer 130 multiplexes first to N^{th} downstream optical signals input through the first to N^{th} demultiplexing ports, and outputs the multiplexed signal to its multiplexing port. The wavelength division multiplexer 130 may include an 1×N arrayed waveguide grating (AWG).

The first to N^{th} optical transceivers 120-1 to 120-N are connected to the first to N^{th} demultiplexing ports of the wavelength division multiplexer 130 in one-to-one relationship. The N^{th} optical transceivers 120-N receives N^{th} downstream injection light and an N^{th} upstream optical signal, and transmits an N^{th} downstream optical signal. The N^{th} optical transceivers 120-N includes an N^{th} downstream optical transmitter (DTX) 122-N, an N^{th} upstream optical receiver (URX) 124-N, and an N^{th} wavelength division multiplexing filter (FT) 126-N.

The N^{th} wavelength division multiplexing filter 126-N includes first to third ports, in which the first port is connected to the N^{th} demultiplexing port of the wavelength division multiplexer 130, the second port is connected to the N^{th} downstream optical transmitter 122-N, and the third port is connected to the N^{th} upstream optical receiver 124-N. The N^{th} wavelength division multiplexing filter 126-N outputs N^{th} downstream injection light, which has been input from the wavelength division multiplexer 130, to the N^{th} downstream optical transmitter 122-N. The N^{th} wavelength division multiplexing filter 126-N outputs an N^{th} upstream optical signal, which has been from the wavelength division multiplexer 130, to the N^{th} upstream optical receiver 124-N. In addition the N^{th} wavelength division multiplexing filter 126-N outputs an N^{th} downstream optical signal, which has been from the N^{th} downstream optical transmitter 122-N, to the wavelength division multiplexer 130.

The N^{th} downstream optical transmitter 122-N receives N^{th} downstream injection light from the N^{th} wavelength division multiplexing filter 126-N, creates an N^{th} downstream optical signal having the same wavelength as that of the received N^{th} downstream injection light, and outputs the created N^{th} downstream optical signal to the N^{th} wavelength division multiplexing filter 126-N. The N^{th} downstream optical transmitter 122-N may includes a Fabry-Perot laser diode or a reflective semiconductor optical amplifier.

The N^{th} upstream optical receiver 124-N photo-electrically converts an N^{th} upstream optical signal input from the N^{th} wavelength division multiplexing filter 126-N into an electrical signal.

The main controller 170 determines an upstream optical signal having the minimum power, from among first to N^{th} upstream optical signals detected by the first to N^{th} optical transceivers 120-1 to 120-N. The main controller 170 controls the secondary controller 180 such that the secondary controller 180 increases the cross coupling ratio of the coupler 160 when the minimum power is greater than a predetermined highest permissible value, and that the secondary controller 180 decreases the cross coupling ratio of the coupler 160 when the minimum power is less than a predetermined lowest permissible value. That is, the main controller 170 controls the secondary controller 180 such that the minimum power has a value within the optimum range.

The secondary controller 180 applies an electric current to the coupler 160 according to the control of the main controller 170, thereby adjusting the cross coupling ratio.

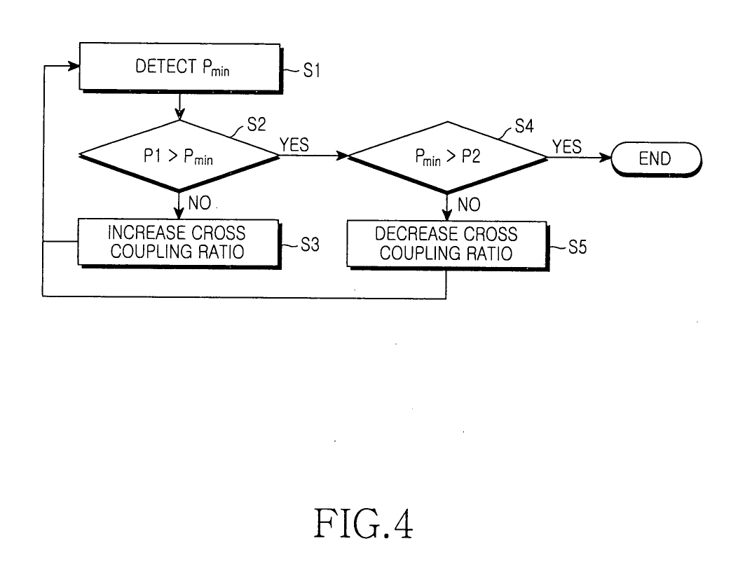

FIG. 4 is a flowchart illustrating the control algorithm of the controllers 170 and 180. The control algorithm of the controllers 170 and 180 may be achieved by following steps 1 to 5.

In step 1, the main controller 170 determines an upstream optical signal having the minimum power Pₘᵢₙ, from among first to N^{th} upstream optical signals detected by the first to N^{th} optical transceivers 120-1 to 120-N.

In step 2, the main controller 170 determines if the minimum power Pₘᵢₙ is less than a predetermined highest permissible value P1. Step 3 is performed when it is determined that the minimum power Pₘᵢₙ is greater than a predetermined highest permissible value P1, but step 4 is performed when it is determined that the minimum power Pₘᵢₙ is less than a predetermined highest permissible value P1.

In step 3, the controllers 170 and 180 increase the cross coupling ratio of the coupler 160 so that the minimum power Pₘᵢₙ may have a value within the predetermined optimum range of P2 to P1. Thereafter, step 1 is again performed in order to determine if the minimum power Pₘᵢₙ has a value within the predetermined optimum range.

In step 4, the main controller 170 determines if the minimum power Pₘᵢₙ is greater than a predetermined lowest permissible value P2. When it is determined that the minimum power Pₘᵢₙ is greater than a predetermined lowest permissible value P2, the procedure is ended. In contrast, when it is determined that the minimum power Pₘᵢₙ is less than a predetermined lowest permissible value P2, step 5 is performed.

In step 5, the controllers 170 and 180 decrease the cross coupling ratio of the coupler 160 so that the minimum power Pₘᵢₙ may have a value within the predetermined optimum range of P2 to P1. Thereafter, step 1 is again performed in order to determine if the minimum power Pₘᵢₙ has a value within the predetermined optimum range.

Steps 1 to 5 may be continuously repeated until the minimum power Pₘᵢₙ has a value within the predetermined optimum range, or may be repeated at a predetermined interval.

Referring again to FIG. 1, the remote node 200 includes a wavelength division multiplexer 210.

The wavelength division multiplexer 210 includes a multiplexing port and first to N^{th} demultiplexing ports. The multiplexing port is connected to the feeder fiber 190, and the first to N^{th} demultiplexing ports are connected to the first to N^{th} division fibers 220-1 to 220-N in one-to-one relationship. The wavelength division multiplexer 210 spectrum-slices upstream-band light input through its multiplexing port so as to generate first to N^{th} upstream injection light, and outputs the generated first to N^{th} upstream injection light through the first to N^{th} demultiplexing ports in one-to-one relationship. Also, the wavelength division multiplexer 210 demultiplexes a multiplexed downstream optical signal input through its multiplexing port into first to N^{th} downstream optical signals, and outputs the first to N^{th} downstream optical signals to the first to N^{th} demultiplexing ports by one to one. The wavelength division multiplexer 210 multiplexes first to N^{th} upstream optical signals input through the first to N^{th} demultiplexing ports, and outputs the multiplexed signal to its multiplexing port. The wavelength division multiplexer 210 may include an 1×N arrayed waveguide grating.

The subscriber-side apparatus 230 includes first to N^{th} optical transceivers 240-1 to 240-N.

The first to N^{th} optical transceivers 240-1 to 240-N are connected to the first to N^{th} division fibers 220-1 to 220-N in one-to-one relationship. The N^{th} optical transceivers 240-N receives N^{th} upstream injection light and an N^{th} downstream optical signal, and transmits an N^{th} upstream optical signal. The N^{th} optical transceivers 240-N includes an N^{th} upstream optical transmitter (UTX) 242-N, an N^{th} downstream optical receiver (DRX) 244-N, and an N^{th} wavelength division multiplexing filter (FT) 246-N.

The N^{th} wavelength division multiplexing filter 246-N includes first to third ports, in which the first port is connected to the N^{th} division fiber 220-N, the second port is connected to the N^{th} upstream optical transmitter 242-N, and the third port is connected to the N^{th} downstream optical receiver 244-N. The N^{th} wavelength division multiplexing filter 246-N outputs N^{th} upstream injection light, which has been input from the N^{th} division fiber 220-N, to the N^{th} upstream optical transmitter 242-N. The N^{th} wavelength division multiplexing filter 246-N outputs an N^{th} downstream optical signal, which has been from the N^{th} division fiber 220-N, to the N^{th} downstream optical receiver 244-N. In addition, the N^{th} wavelength division multiplexing filter 246-N outputs an N^{th} upstream optical signal, which has been from the N^{th} upstream optical transmitter 242-N, to the N^{th} division fiber 220-N.

The N^{th} upstream optical transmitter 242-N receives N^{th} upstream injection light from the N^{th} wavelength division multiplexing filter 246-N, creates an N^{th} upstream optical signal having the same wavelength as that of the received N^{th} upstream injection light, and outputs the created N^{th} upstream optical signal to the N^{th} wavelength division multiplexing filter 246-N. The N^{th} upstream optical transmitter 242-N may include a Fabry-Perot laser diode or a reflective semiconductor optical amplifier.

The N^{th} downstream optical receiver 244-N photo-electrically converts an N^{th} downstream optical signal input from the N^{th} wavelength division multiplexing filter 246-N into an electrical signal.

As described above, according to the wavelength-division-multiplexed light source and the wavelength-division-multiplexed passive optical network using the same based on the present invention, the loss characteristics of a transmission optical signal is detected, and the cross coupling ratio of the coupler is adjusted depending on the detected loss characteristics, thereby efficiently maintaining signal quality.

While the present invention has been shown and described with reference to certain preferred embodiments thereof, it will be understood by those skilled in the art that various changes in form and details may be made therein without departing from the spirit and scope of the invention as defined by the appended claims. Accordingly, the scope of the invention is not to be limited by the above embodiments but by the claims and the equivalents thereof.

What is claimed is:

1. A wavelength-division-multiplexed light source for transmitting and receiving broadband light via a fiber, comprising:
a light source for outputting the broadband light; and
a coupler for outputting the broadband light from the light source to the fiber through a cross coupling, and outputting an optical signal from the fiber through a bar coupling based on a predetermined cross coupling ratio, wherein the cross coupling ratio of the coupler is adjusted depending on a power of the optical signal.

2. The wavelength-division-multiplexed light source as claimed in claim 1, further comprising:
an optical receiver for detecting an optical signal output from the coupler; and
a controller for adjusting the cross coupling ratio of the coupler depending on a power of the detected optical signal.

3. The wavelength-division-multiplexed light source as claimed in claim 2, wherein the wavelength-division-multiplexed light source comprises a plurality of optical receivers for detecting a plurality of optical signals input from the fiber through the coupler, and
the controller adjusts the cross coupling ratio of the coupler depending on a minimum power from among powers of the detected optical signals.

4. The wavelength-division-multiplexed light source as claimed in claim 3, wherein the controller increases the cross coupling ratio when the minimum power is greater than a predetermined highest permissible value, and decreases the cross coupling ratio when the minimum power is less than a predetermined lowest permissible value.

5. The wavelength-division-multiplexed light source as claimed in claim 3, further comprising a wavelength division multiplexer, which demultiplexes a plurality of optical signals input from the fiber through the coupler, and outputs the demultiplexed optical signals to the optical receivers in one-to-one relationship.

6. A wavelength-division-multiplexed passive optical network comprising:
a central office; and
a subscriber-side apparatus coupled to the central office through a feeder fiber,
wherein the central office comprises an upstream broadband light source for outputting upstream-band light; a plurality of optical transceivers for detecting input upstream optical signals; a coupler for outputting the upstream-band light from the upstream broadband light source to the feeder fiber through a cross coupling, and outputting upstream optical signals from the feeder fiber to the optical transceivers through a bar coupling based on a predetermined cross coupling ratio; and a controller for adjusting the cross coupling ratio of the coupler depending on powers of the detected upstream optical signals.

7. The wavelength-division-multiplexed passive optical network as claimed in claim 6, wherein the controller adjusts the cross coupling ratio of the coupler depending on a minimum power from among powers of the detected optical signals.

8. The wavelength-division-multiplexed passive optical network as claimed in claim 7, wherein the controller increases the cross coupling ratio when the minimum power is greater than a predetermined highest permissible value, and decreases the cross coupling ratio when the minimum power is less than a predetermined lowest permissible value.

9. The wavelength-division-multiplexed passive optical network as claimed in claim 6, further comprising a wavelength division multiplexer, which demultiplexes a plurality of upstream optical signals input from the feeder fiber through the coupler, and outputs the demultiplexed optical signals to the optical transceivers in one-to-one relationship.
